(19) United States
(12) Patent Application Publication
(10) Pub. No.: US 2016/0227025 A1
(43) Pub. Date: Aug. 4, 2016

(54) SYSTEM AND METHOD OF MULTIPLE VOICE CALL HANDLING

(71) Applicant: Christian Soby, Hjoerring (DK)

(72) Inventor: Christian Soby, Hjoerring (DK)

(21) Appl. No.: 14/611,098

(22) Filed: Jan. 30, 2015

(51) Int. Cl. H04M 3/02; H04M 19/04; H04M 19/02

(52) U.S. Cl. CPC H04M 3/02; H04M 19/026; H04M 19/042

(57) ABSTRACT

A system, article, and method of multiple voice call handling.

### BACKGROUND

Conventionally, most mobile phones are limited to one phone line. Mobile phone users, however, often desire multiple phone lines to have one phone line for personal calls and another phone line for business calls. To accomplish this, the user may have multiple mobile phones which is cumbersome and inconvenient. Thus, some mobile phones have multiple phone lines referred to as dual subscriber identification module (SIM or SIM card) phones. These multiple line mobile phones, however, merely provide simple on-hold/active features where one call is placed on hold, while the phone user listens to the other call. The user can then switch between calls typically by pressing a button on the phone but can only hear one call at a time. The mobile phones also may provide a conferencing feature where the two lines may be combined into a single group phone call so that everyone calling can hear everyone else on the group line unless one of the lines forming the group is muted. In that case, a user on the muted line can hear everyone else but the group cannot hear them.

In an environment where multi-tasking is common, it is desirable to listen to multiple separate phone calls at the same time in order for a user to know when to pay more careful attention, or when to speak, for any one of the multiple phone calls. For example, during a phone conference, a private call may be incoming. The user may desire to keep listening to the phone conference in the background while serving the private call so the user can interrupt the private call and switch to the phone conference when the user hears from the conversation in the phone conference that his attention is needed in the phone conference call.

By another example, while waiting in a phone queue (for example, in a customer service call), the user may receive a second call (or want to make another call). The user may want to continue listening to the phone queue in the background of the second call so that the user can switch back to the service call when the user hears that he or she is next in line (it is the user's turn). None of these conventional telephone systems, however, provide the ability to the user to listen to multiple separate calls to perform these and other functions.

### DESCRIPTION OF THE FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a schematic diagram showing a voice communication system;

FIG. 2 is a schematic diagram showing a portion of the voice communication system;

FIG. 3 is a flow chart of a method of handling multiple voice phone calls;

FIG. 4 is a detailed flow chart of a method of handling multiple voice phone calls;

FIG. 5 is a simplified diagram of a phone network;

FIGS. 6A-6B are schematic diagrams of the voice communication system handling multiple calls;

FIG. 6C is a schematic diagram of the voice communication system handling a conference call;

FIG. 7 is an illustration of an example user interface for use by the voice communication system described herein;

FIG. 8 is a schematic diagram of voice communication system in operation;

FIG. 9 is an illustrative diagram of an example system;

FIG. 10 is an illustrative diagram of another example system; and

FIG. 11 illustrates another example device, all arranged in accordance with at least some implementations of the present disclosure.

### DETAILED DESCRIPTION

One or more implementations are now described with reference to the enclosed figures. While specific configurations and arrangements are discussed, it should be understood that this is performed for illustrative purposes only. Persons skilled in the relevant art will recognize that other configurations and arrangements may be employed without departing from the spirit and scope of the description. It will be apparent to those skilled in the relevant art that techniques and/or arrangements described herein also may be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as telephones including land-line or wired phones or mobiles phones such as dedicated phones or smartphones, loud speaker systems and conference call systems with phone service, and otherwise any device that may provide telephone service such as laptop or desktop computers, tablets, video game panels or consoles, high definition audio systems, surround sound or neural surround home theatres, television set top boxes, and so forth, may implement the techniques and/or arrangements described herein. Further, while the following description may set forth numerous specific details such as logic implementations, types and interrelationships of system components, logic partitioning/integration choices, and so forth, claimed subject matter may be practiced without such specific details. In other instances, some material such as, for example, control structures and full software instruction sequences, may not be shown in detail in order not to obscure the material disclosed herein. The material disclosed herein may be implemented in hardware, firmware, software, or any combination thereof.

The material disclosed herein also may be implemented as instructions stored on a machine-readable medium or memory, which may be read and executed by one or more processors. A machine-readable medium may include any medium and/or mechanism for storing or transmitting information in a form readable by a machine (for example, a computing device). For example, a machine-readable medium may include read-only memory (ROM); random access memory (RAM); magnetic disk storage media; optical storage media; flash memory devices; electrical, optical, acoustical or other forms of propagated signals (e.g., carrier waves, infrared signals, digital signals, and so forth), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, and so forth, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

Systems, articles, and methods of multiple voice call handling.

Many telephone systems whether wired land-line based networks or wireless mobile phone networks are typically limited such that the phones only handle one call at a time. In other words, at any one time, the user only hears a single voice signal from either a single phone or a merged signal from a conference call. For mobile phone networks where each phone has a single subscriber identification module (SIM or SIM card), the network, rather than the phone, handles the line switching and merging when call-waiting functions or conference call functions are provided. Also in these cases where multiple phone lines are desired, some users simply own two or more phones such as one phone for personal matters and one phone for business matters. This, however, can become cumbersome. In order to provide this functionality at a single phone, some mobile phones handle two separate lines or phone calls in parallel. Thus, some current dual SIM phones with two SIM cards also support two active calls in parallel, but merely provide simple handling of the audio including the “on hold/active” function where the user toggles between the two calls, or conferencing function between the two calls where all parties can hear each other (unless one of the parties hits mute so the user cannot be heard by any of the other callers on the conference line). Thus, a conventional dual-SIM smart phone does not treat these phone calls as independent tasks. Instead, the phone treats the calls either as exclusive (active/hold) or merged (conferencing).

Herein, the terms line, phone line, call, or phone call refer to the same thing, which is an independent audible or voice communication between two remote devices regardless of whether the communication is provided as signals over telecommunication networks or streaming data from computer networks such as from online video phone applications on a WAN such as the internet. Thus, a phone line can be a public switched telephone network (PSTN) connection, VoIP connection by LAN, WLAN, or WAN, cellular data connection, or other data connections such as any voice call online provider or voice part of a video call, cellular voice call, and so forth.

Also herein, a voice signal refers to any audible signal typically used to communicate between audio communication devices. Thus, the contents of a voice signal as used herein is not necessarily limited to communication of a human voice but could be a computer generated voice or otherwise other sounds that may be used for communication and that is compatible with what typically would be considered to be a phone call or phone line.

A signal may refer to either an entire communication or a portion of a communication, such as an utterance or sentence for example, depending on the context, and that provides audible content, and by one example typically complying with a known phone protocol whether in digital or analog form. Thus, online data streaming that provides data of such a phone call or phone line is considered to be an audio or voice signal for purposes of the multiple phone call handling methods, systems, and devices herein.

Many phone users prefer to multi task and have the ability to listen to separate simultaneous conversations (or phone calls) and turn their attention to a particular conversation when needed to do so. Thus, such users desire audio handling that support these abilities. For example, a user may be participating in a phone conference among multiple callers on one phone line when a separate private call on another phone line is incoming (or is made by the user) on the same phone. In this case, the user may want to keep listening to the phone conference in the background while serving the private call so he can interrupt the private call when his attention is needed in the conference call. In another situation, while “waiting” in a phone queue (for example, waiting for the user's turn on a customer service call), the user may receive (or initiate) a second call. In this case, the user may like to continue listening to the phone queue in the background of the second call so that the user can switch back to the service call when the service customer company provides an indication that it is the customer's turn in the service call.

In order to provide these multi-tasking functions, a single voice communication device such as a land-line based or mobile phone may provide intelligent mixing of two separate audio streams so that a user can listen to multiple simultaneous phone calls on the single device. This can be accomplished by separately controlling, routing, and enhancing of the downlink audio from the two calls to fulfill the desired functionality explained above. Particularly, the voice enhancement and routing of the downlink from two active calls (say line 1 and line 2) should be kept separate to enable the user to listen to both calls at the same time whether on a single speaker or on two or more separate speakers. The outgoing or uplink voice signal from the user can be selectively switched between line 1 and line 2. This is accomplished by having a switch that receives the outgoing signal after the system performs uplink enhancement to the signal. This switch may route the voice to either line 1 or 2. The other line will be left in silence since no voice is sent to that line.

With this arrangement, signal volume level and routing of the two downlink voice signals can be handled independently so that a user can easily and simultaneously listen to two different calls. The phone can make the more desirable downlink louder while maintaining the other downlink audible but in the background. When using stereo headphones, the stereo functions can be used so that one call can be routed to a right channel (and one ear) and another call can be routed to the left channel (and the other ear). Otherwise, for voice communication devices with a single speaker such as a loud speaker or single speaker headset (or otherwise when desired), the two signals of the calls can be mixed, but the mixing occurs after enhancements are performed on the signals separately. For the uplink, a microphone signal may be routed to the desired call. An activator such as a user interface may be provided to activate any of the options mentioned herein. Thus, a user interface, such as a touch sensitive display on a smartphone as one non-limiting example, may indicate how many calls are established, a user activation to set the volume for each call, and a switch to select which of the calls are to receive the uplink signal. This method may apply to two or more voice signals.

Also, the conventional conferencing function is very complex when a good quality sound is expected since the incoming signals are often mixed before the signal is enhanced initially resulting in a relatively lower quality mixed audio signal. Conventionally, a phone service provider establishes the hub of the conference calls externally to the phones, especially phones with a single line. Otherwise, for known conventional conferencing voice flow for phones with multiple phone lines, the voice signals are mixed after voice coding but before voice enhancement. This has a number of drawbacks. If there is (and this there always is) a volume level difference between phone lines, background noise and so forth in the speech from the different voice signals on the different lines will be mixed together and difficult to mitigate later. For example, if one person in a conference call speaks too loud and another speaks too softly, then the listeners cannot fix this by adjusting their volume level since a single volume is fixed for the mixed signal at the enhancement stage. Also, the conventional conference mode creates the potential of undesirable information sharing between the two calls since a user cannot simply mute for one party while talking to another party on the conference call. Anything that is stated when the phone line is open is audible to any of the parties on the conference call.

To resolve these further issues, the architecture and configurations used here can be used efficiently for locally-based conference calls as well. Instead of the conventional flow, the routing for the conference call is provided with independent voice enhancement on each downlink voice stream which eliminates or reduces the complexity and quality problems. Furthermore, the ability to switch the uplink signal to one of the parties and not others on the conference call reduces the risk of providing information to a party on the locally-based conference line.

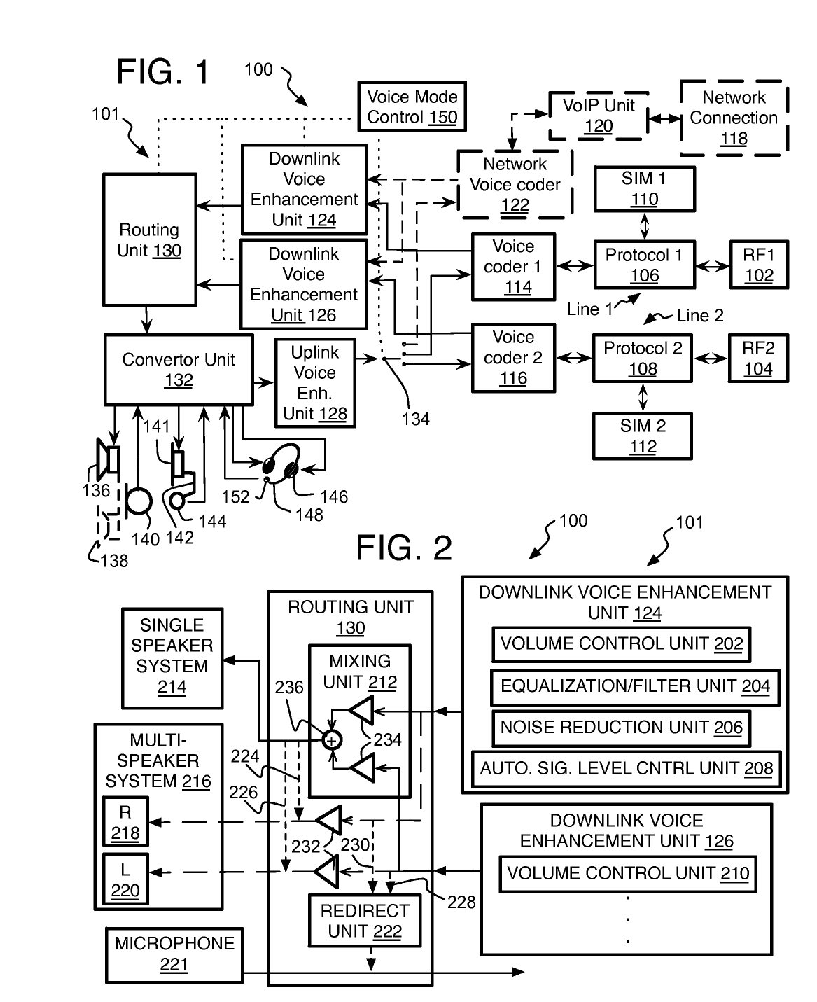

Referring now to FIGS. 1-2, a voice communication device or system 100 may have a phone call handling unit 101 to provide the features described herein. The voice communication device or system 100 may be a land-line or wired telephone or may be a wireless or mobile phone. Otherwise, the voice communication device 100 may be any device able to provide telephonic services, and may include a headphone or headset, a loud speaker, a stereo system, a television, video game console, cable system, or any other entertainment system with telecommunication capabilities. The voice communication device 100 also may be any computer device that has telecommunications capability such as desktop or laptop computers, tablets, wearable computer devices and so forth that is capable of steaming data of telephonic signals, or any combination of the devices mentioned herein.

The phone call handling unit 101 may receive typical subscriber telephone service for at least two phone lines that transmits telephonic signals. The signals at least provide audio but may be signals capable of providing, or that are included with, video transmissions as well. At least the audio signals may be received by radio frequency (RF) receivers 102 and 104 tuned to telephonic frequencies. The audio signals may be read and/or formatted according to certain known protocols 106 and 108, and in some forms, authenticated when passing security measures such as those processed by corresponding subscription identification modules (SIMs). Voice communication device 100 is shown here to be a dual SIM mobile phone to provide the two separate phone lines but it may be possible to provide more phone lines than two. The audio signals from the two phone lines are then passed to voice coders 1 and 2 (114 and 116) for decoding of the incoming audio signals. The coders may follow known coding standards such as Adaptive Multi-Rate Narrowband or Wideband (AMR-NB or AMR-WB).

The decoded audio signals are then enhanced and routed as described below to provide the call handling features described herein so that a user can simultaneously listen to multiple phone calls and choose which phone call to talk on. This is controlled by a voice mode control 150 that receives a user's preferences, when provided, regarding the multiple phone calls and initiates the appropriate settings. Thus, the voice mode control 150 may set parameters and settings in downlink voice enhancement units 124 and 126 that modify or enhance the audio signals in a number of different ways to increase the quality of the signal or modify other features such as volume either automatically or according to users' selections. By one form, the phone call handling unit 101 may effectively provide a downlink voice enhancement unit for each phone line (or audio signal) handled by the voice communication device 100. It will be understood that each RF, protocol, coder, and enhancement unit processing a signal establishes a phone line generally referred to as line 1 and line 2.

While only two subscriber phone lines are shown, the voice communication unit could work with more lines, or could be less than two such as one or none when an internet connection is provided to form an on-line phone connection as well. In this case, a network connection 118 may provide an additional or alternative phone line. Such a network connection may be a wired Ethernet connection or a wireless Wi-Fi or any other WAN or LAN connection to a computer network that may provide audio telecommunications signals in the form of streaming data. A voice over internet protocol (VoIP) unit 120 may be provided to modify the audio signal according to the protocol, and then a network voice coder 122 may perform any decoding of the audio signal that needs to be performed before emission of the audio signal. By one example, such coding may be performed with any appropriate International Telegraph Union Telecommunication Standardization Sector standards such as G.711 and G.722. The decoded audio signal then may be provided to the downlink voice enhancement units as with the other telecommunications audio signals.

The details for downlink enhancement are provided below with regard to FIG. 2. Continuing the description of the voice communication device, once each signal has been enhanced, the signals may be provided to a routing unit 130 that may mix the signals when a single speaker is provided for all simultaneous signals, or may be kept separate when stereo speakers are provided. Otherwise, the routing unit 130 may also direct the incoming audio signals to other phone lines of other voice communication devices in a locally-based conference call mode as described below. The incoming (or downlinked) signals may be sent to a convertor 132 that may provide drivers, digital to analog conversion, and other modifications so that the signals can be emitted through the speakers. By one example, this may include through a single loud speaker 136, or there may be one or more loud speakers 138 to form at least a right and left speaker for a stereo system. In such a case, there may be a separate microphone 140 provided to receive sound waves from the voices of the user or users and convert them into outgoing or uplink audio signals. By other forms, a headset 142 may have a single ear piece speaker 141 and a microphone 144 for receiving and transmitting audio signals. Otherwise, the audio signal may be emitted through left and right stereo speakers 146 on a headphone 148 that also has its own microphone 152. There is no limitation as to the type of speaker or speaker arrangement except that the present system may provide for situations that only have a single speaker or multiple speakers or optionally either of these alternatives as explained below.

More specifically, while a downlink voice enhancement unit is shown to be effectively provided for each phone line, in actuality, there may be a single enhancement unit module or program that simultaneously performs independent enhancement of each phone line of multiple phone lines provided. This may be accomplish by using a multi-channel compressor. The downlink voice enhancement unit 124 or 126 may have a volume control unit 202 to individually control the volume for each line or call by modifying the amplitude of the audio signal for a phone line by one example. In some of the forms described below, the volume may be manually or automatically set so that a call to be monitored in the background has a lower volume and the call to be paid more attention by the user has a higher volume as described below. An equalization or filter unit 204 and a noise reduction unit 206 may be provided to smooth and refine the quality of the incoming audio signal for a phone line, and an automatic level control unit 208 may be provided to provide the appropriate power levels.

The enhanced incoming signals then may be provided to the routing unit 130 to direct the signals to the appropriate speaker system for emission, and/or for the locally-based conference mode, back to one of the phone lines for transmission to one of the other voice communication devices conducting the phone calls. Particularly, the routing unit 130 may direct the audio signals to amplifiers 232 and then through to a multi-speaker system 216 such as a stereo system with at least right and left speakers 218 and 220 for example. Such a system may have more than two speakers where one audio signal from one call can be audible on one speaker while another audio signal from another call can be audible on at least one different speaker of such a system. When the audio signals from the phone lines are to be directed to a single speaker system 214 for emission, the routing unit 130 may have a mixing unit 212 to mix the signals to share a single wire to the single speaker system 214. The mixing unit may first amplify the signals with amplifiers 234 and then use an adder 236 to mix the signals in ways detailed below.

Alternatively or additionally, the mixed signals may be provided to a multi-speaker system as shown by arrows 224 and 226, and when desired by the user. In this case, the user may want to hear both calls in both or all speakers such as on a headphone.

Microphones 144 or 152 may provide outgoing audio signals to be passed through the convertor 132 for analog-to-digital conversion and any other modification that should occur before enhancing the outgoing signal at an uplink voice enhancement unit 128. Specifically, a microphone 221 like microphone 144 or 152, may be provided to form an outgoing audio signal that may be directed by the routing unit 130 to the uplink voice enhancement unit 128. This uplink enhancement also may include volume control, equalization, filtering, noise reduction, automatic level control, echo removal, and so forth. A switch 134 may be controlled to direct the outgoing audio signal(s) to one or more of the selected phone lines as described below. The switch may be realized by adjustable gain cells on the two lines so that desired switching and/or mixing can be obtained by controlling the gain cells between mute and full signal.

In either of the cases described above (single or multiple speakers), a conference call established remote from the voice communication device 100 is treated as a single incoming audio signal or phone line. By one alternative, however, a locally-based conference call may be provided, and in this case, the routing unit 130 has a re-directing unit 222 that redirects a copy of the incoming audio signal(s) obtained as shown by arrows 228 and 230 shown in dash and back out to the uplink voice enhancement unit 128 and to switch 134 so that each phone line may hear the audio signal from the other phone lines (and/or originated from the voice communication device 100) to optionally and effectively establish a locally-based conference call when so desired.

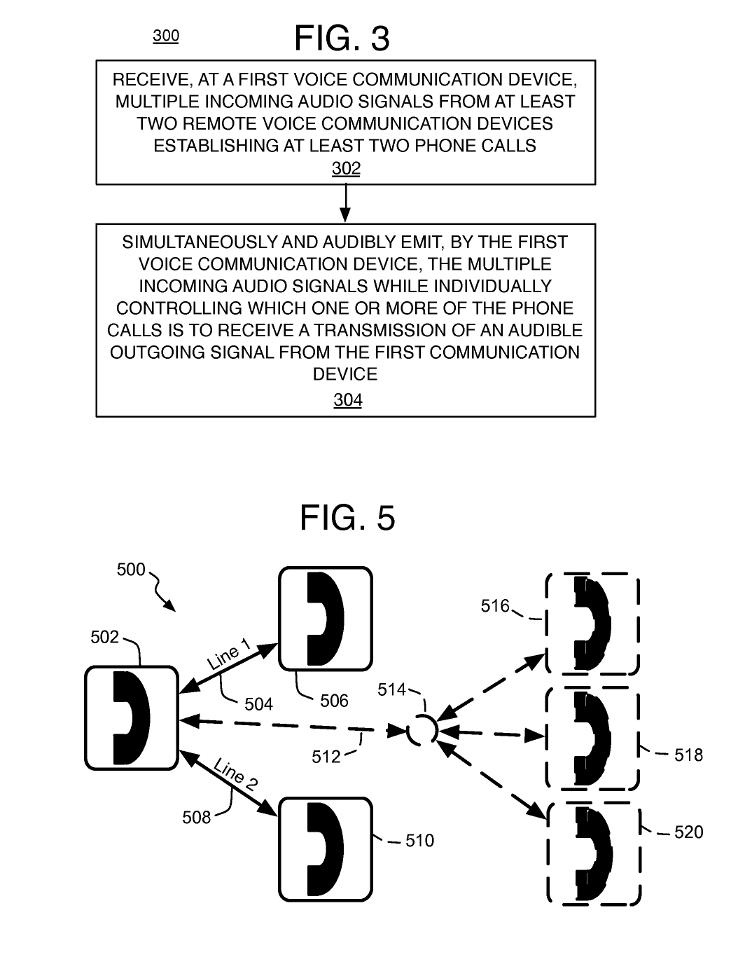

Referring to FIG. 3, an example process 300 for a computer-implemented method of multiple voice call handling is provided. In the illustrated implementation, process 300 may include one or more operations, functions, or actions as illustrated by one or more of operations 302 to 304 numbered evenly. By way of non-limiting example, process 300 may be described with reference to example voice communication devices described herein with any of FIGS. 1-2, 5-7, and 9-11, and where relevant.

Process 300 may include “receive, at a first voice communication device, multiple incoming audio signals from at least two remote voice communication devices establishing at least two phone calls” 302. In other words, the audio signals may include two separate private calls on separate phone lines, or where one call is a conference call and the second call is a private call. Otherwise, the multiple calls may be separate signals that are locally directed for a conference call as described below. The calls may be initiated by the first voice communication device as an outgoing request for the call or may be initiated from other voice communication devices. Also, there may be more than two simultaneous calls on more than two phone lines.

Process 300 also may include “simultaneously and audibly emit, by the first voice communication device, the multiple incoming audio signals while individually controlling which one or more of the phone calls is to receive a transmission of an audible outgoing signal from the first communication device” 304. As described in detail herein, a user of a voice communication device, such as a mobile phone that receives multiple separate phone calls, can listen to multiple calls at the same time without the callers being able to hear each other. Thus, the user can monitor one call while listening more closely to another call. The user may also be permitted to switch the outgoing audio or voice signal to any one of the calls.

By other options, the volume is manually or automatically adjusted so that the volume of a call being monitored is lower than the volume of the call the user believes is more important, or the user is talking on (or in other words, that currently receives the outgoing audio signal).

By other examples, optionally, two or more calls may hear the user simultaneously to create a locally-based conference call. Such a locally-based conference call may be established when the user (or system) selects multiple or all of the phone lines to receive the outgoing uplink signal.

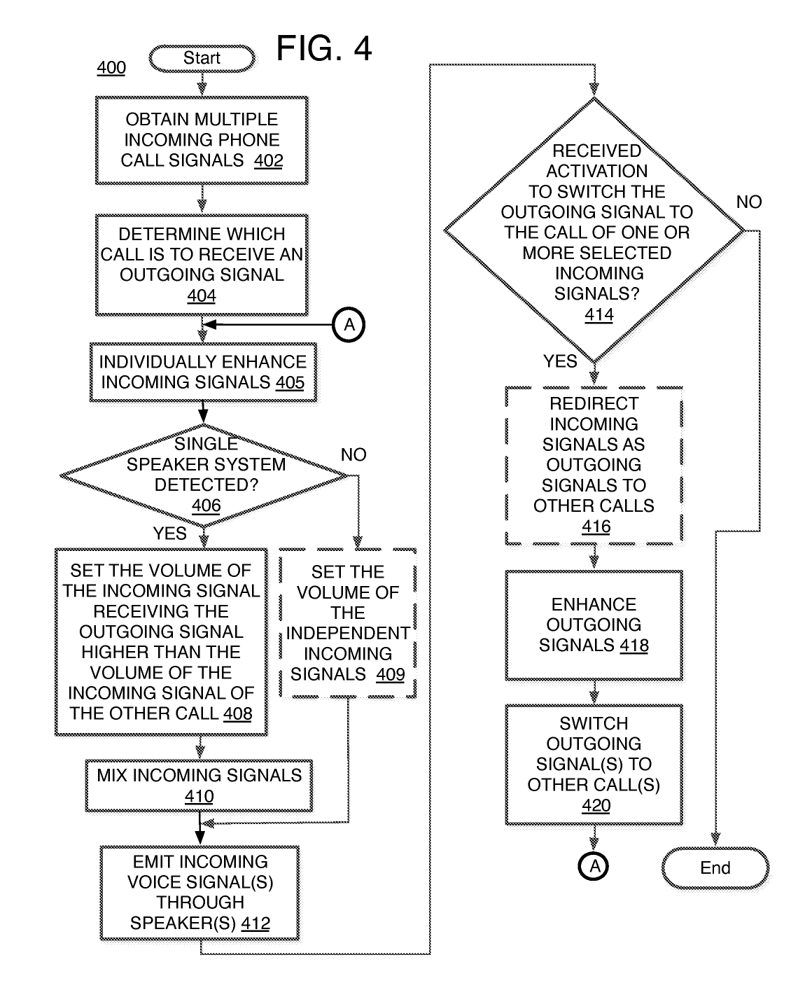

Referring now to FIG. 4, an example computer-implemented process 400 for multiple voice call handling may include one or more operations, functions or actions as illustrated by one or more of operations 402 to 416 numbered evenly. By way of non-limiting example, process 300 may be described herein with reference to example voice communication devices with multiple phone call handling described herein with any of FIGS. 1-2, 5-7, and 9-11, and where relevant.

Process 400 may include “obtain multiple incoming phone call signals” 402. As mentioned, the voice communication device may receive multiple audio or voice signals for telephonic communication. This establishes multiple phone calls on multiple phone lines of a voice communication device, by some examples, the phone lines may be considered traditional subscriber or public switched telephone network (PTSN) type phone lines and/or online VoIP data streaming type of phone lines or any combination thereof. Many other alternatives for establishing phone lines are described below with voice communication device 900. Thus, the present methods apply to a device that can receive and handle multiple phone calls in a parallel such as a dual-SIM card mobile phone for example, or a single SIM card phone that also receives WI-FI signals (or data streaming), or any combination thereof as long as two or more phone calls can be handled at once.

Referring to FIG. 5, telecommunications network 500 is provided to show example networks that may be used with the multiple phone call handling methods described herein. Specifically, where voice communication device 502 provides multiple phone call handling and has the ability to handle multiple phone lines, remote voice communication devices 506 and 508 may hold separate phone calls along line 1 (504) and line 2 (508) by listening to both calls at the same time and switching the outgoing signal between the calls as desired, or by providing a locally-based conference call such that the voice communication devices 502, 504, 506 all receive outgoing signals from each other so that all parties can hear the other parties. Alternatively, or additionally, one of the lines 512 to the voice communication device 502 may itself be a conference call line that has an external hub 514 (such as at a service provider or another voice communication device) that interconnects with other callers on other voice communication devices 516, 518, 520 on the conference call line 512.

This operation regarding receiving of the incoming phone call signals also may include (or precede) processing the signals to be ready for enhancement. Thus, this may include applying RF or VoIP protocols to read and/or initially format the signals, authenticating the signals using SIM cards, and decoding the signals as described above with device 100.

Process 400 may include “determine which call is to receive an outgoing signal” 404. Thus, by one form the user of the voice communication device establishing the multiple calls (either by receiving a call or by initiating the call) may choose which one or more of the lines to transmit the user's outgoing or uplink voice signal to. The user may select only one of the lines, all of the lines which may trigger a locally-based conference call, or any other number of lines available as desired. For example, the user may have the user's outgoing signal audible on only two of three lines for example.

Referring to FIG. 7, by one form, an example user interface 700 is provided on the voice communication device or other convenient location for the user to select which lines to transmit the outgoing signal to. Thus, user interface 700 in this example is a picture on a touch-sensitive display screen that may have two or more call identification fields 702 and 704 that each identify one of the established phone calls on a phone line. The identification field may simply list or number the calls as call 1, call 2, and so forth as shown, or the fields may list some sort of identification of the caller on the phone line, such as by an automatic search through a contacts database for example. Many other examples exist such as the user either previously or currently (such as while establishing or during the call) entering the user's own identification names or labels for the calls. It will be understood that instead of a vertical list of calls, the calls may be listed by splitting the screen left and right for two phone calls, or any other logical division.

The user interface 700 also may have a virtual (on screen operated by touch) toggle, switch, or other device. The user may simply touch the particular call's division or side of the screen 714 or 716, of the identification field 702 or 704 to select the call or calls that should receive the outgoing signal. Otherwise, the illustrated examples may use check boxes 706 and 708 shown so that the user can select which of the listed lines are to receive the outgoing signal from the user's voice communication device. It will be appreciated, however, that the selection may be provided on many different devices such as by physical buttons or switches, and so forth, and may or may not be associated with a screen that shows the selection.

It will be understood that the check boxes inherently indicate to the user which line has been selected and receives the outgoing signal. In addition to, or instead of, the check boxes, the selection may be indicated by showing a different color on the screen portions 714 and 716 such as red near or around the call without the outgoing signal, and green near or around the call or calls that receive the outgoing signal. Otherwise, the other elements on the user interface 700 such as the identification fields 702 and 704, or check boxes 706 and 708, also may have their color changed to show the selection. Other ways to indicate the selection may be by separate indicator such as an LED (or lit physical button) near a listing of possible phone call connections or lines, and so forth. The user interface 700 also may have slides 710 and 712 for independently adjusting the volume for each line as described below.

Alternatively, the selection of where to send the outgoing signal may be performed automatically such that the system determines the selection instead of the user. This may occur when the outgoing signal is automatically switched to a call from a private call to an identified high priority call for example. This may be beneficial when switching back and forth from a service call where the user is waiting for the user's turn to make a purchase such as tickets to a sporting or entertainment event such that keeping the user's turn is considered critical to the user while abruptly interrupting the secondary private call is considered acceptable. In these cases, the voice communication device may provide the option to have the device announce that the lines are being switched.

As mentioned, the current solutions offer a switch between two calls or conferencing of the two calls by selecting both calls. This is sufficient for traditional usage of phone lines—either you talk with one or the other, or you have a conference call. By selecting more than one phone line, a locally-based conferencing scenario is established that provides open communication between all selected lines and does not protect the information from line 1 to go to line 2 for example, and for which is described in greater detail below.

Process 400 then may include “individually enhance incoming signals” 405 so that each line is independently enhanced. As mentioned above, this may include equalization, filtering, noise reduction, and automatic signal level control. By some forms, this may include at least an initial setting of volume levels, and specifically set at system defaults unless omitted in favor of the volume control operations explained below. Thus, the complexities of enhancing a mixed signal with multiple voice signals is avoided, and each voice signal is a relatively clean signal now ready for multiple phone call handling functions going forward.

When the voice communication device has a fixed speaker arrangement, such as a single speaker on a land-line based phone, then the speaker arrangement is known. In other cases, however, a determination is needed regarding the speaker arrangement, especially with mobile phone devices, because the speaker arrangement may be variable depending on the possible options provided by a phone and the user's preferences. The mobile phone may be set to use its on-board speaker or speakers. In most of these cases, the multiple phone call handling methods will assume a single speaker is being used even when multiple speakers are present on the phone since “non-speaker” mode (meaning non-loud speaker mode) typically directs the sound to the speaker by the users ear when the mobile phone is held up to the user's ear as a phone. Alternatively, where multiple speakers are on opposite sides of the mobile phone, and the mobile phone is set down as a stereo loud speaker for instance, in this case, the speakers may be treated as two stereo speakers when desired for the methods explained below.

Otherwise, the process 400 may include a check to determine whether “single speaker system detected?” 406. In this case, it is determined whether the mobile phone for example is connected to a wired or wireless single speaker headset or a stereo speaker headphone. Many other examples exist, and this check may be provided for any system that has the possibility of providing a single speaker or multiple speaker function, including those cases where multiple speakers are provided but single speaker operation is manually or automatically selected anyways.

This operation is provided so that the process understands that the signals are to be mixed when a single speaker is provided, or the signals are to be kept separate when multiple speakers are provided. It also indicates that the volume should be controlled independently when the signals are to be mixed for a single speaker so that the higher priority call is easier to hear while the call in monitoring mode is at a lower volume. This volume operation, however, may apply when multiple speakers are provided as well as explained below.

For the case where the signals are to be mixed, process 400 then may include “set the volume of the incoming signal receiving the outgoing signal higher than the volume of the incoming signal of the other call” 408. This feature is provided so that the user can listen to two calls at once except that the current call that the user is speaking on is louder than the call that is merely being monitored. This is provided based on the concept that the human brain is very good at focusing attention on one particular conversation even when a number of conversations are audible in the same vicinity as the first conversation. This known ability is referred to as the cocktail party effect.

When a single speaker is provided such as with a headset with a single mono ear piece or speaker, the process assists to differentiate between the two calls by setting a higher volume for the call that the user is currently conversing in (has the uplink or outgoing signal, and also referred to as the active call) so that it is more audible, and setting a lower volume for the other background call. The volume setting may be performed automatically or manually by using volume adjusters 710 and 712 for example on user interface 700 and that respectively correspond to calls 1 and 2.

When two or more speakers are present to emit two downlink streams independently such as with a stereo system or headphones, the two calls are directed to different speakers, and in the case of headphones, to different ears. This separation to different ears assists the brain to differentiate between the two calls. Thus, one speaker (such as a right speaker) receives the active call, and the other speaker (such as at the left speaker) receives the other call. In these cases, process 400 also may include “set the volume of the independent incoming signals” 409 so that the volume can be set similarly at different levels with multiple speaker systems as with the single speaker system. The different volumes further assist with the differentiation by setting a higher volume for the call at one speaker (such as the right speaker for example) that the user is currently conversing in (that has the active uplink by one example), and sets a lower volume for the background call in the other or left speaker. In this case of multiple speakers, however, it may not always be necessary to adjust the volume of the calls to two different levels when the transmission of the signals to separate ears is sufficient for differentiating the signals. Again, the volume may be set automatically or manually.

It will be appreciated that the option may be provided so that volume may be set to different levels for multiple calls even when one or more other calls are not receiving the uplink or outgoing signal at all. In this case, there may be more than two phone lines, and the volume may be set for one or two calls, but one or two other calls do not receive the uplink signal.

For the single speaker systems, process 400 may include “mix incoming signals” 410. Most audio sub-systems are able to handle two audio streams independently so the two voice streams can be presented to the user in an “intelligently” mixed fashion. By performing the mixing of the voice streams after the individual voice stream enhancement, the signal levels, background noise quality, etc. has been “equalized,” and the clean signals can now be mixed. First, the signals may be amplified to acceptable power levels for the signals before the signals are added together. The signals are then added together by passing each of the two signals through an adjustable gain block that provides full control of levels and mixing by the two signals.

While the mixed signal is then provided to single speakers or single speaker systems, it will be understood that the mixed signal could be provided to a multiple speaker system such as head phones so the same mixed signal is emitted from both speakers to both ears, as might be preferred by the user.

Process 400 may include “emit incoming voice signal(s) through speaker(s)” 412 and as explained, whether a mixed signal through a single speaker or independent signals through multiple speakers, and where the volume may be different for the individual signals whether mixed or not.

The multiple phone call handling process then maintains the pathways for the incoming and outgoing signals until the call is ended or the user indicates a desire to change the target call to receive the outgoing or uplink signal. Thus, process 400 may include a check to determine whether the phone system “received activation to switch the outgoing signal to the call of one or more selected incoming signals” 414. Thus, the process 400 permits the user to serve two or more phone calls independently. The user will hear the downlink voice from all calls mixed intelligently together but the user's voice will only go to the currently selected call, thereby avoiding unintended information sharing between both calls. As mentioned above, a user interface may be provided with checkboxes or color change to an area of the screen, or any other suitable control or switch whether virtual on a touch screen or physical, to indicate a user's desire to change the direction of the outgoing signal.

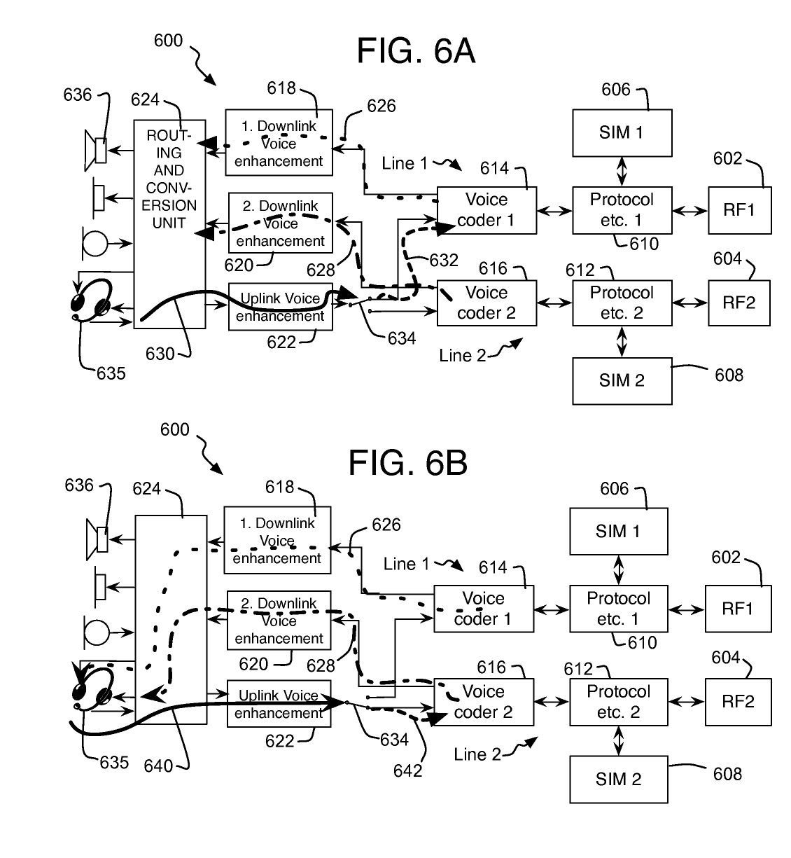

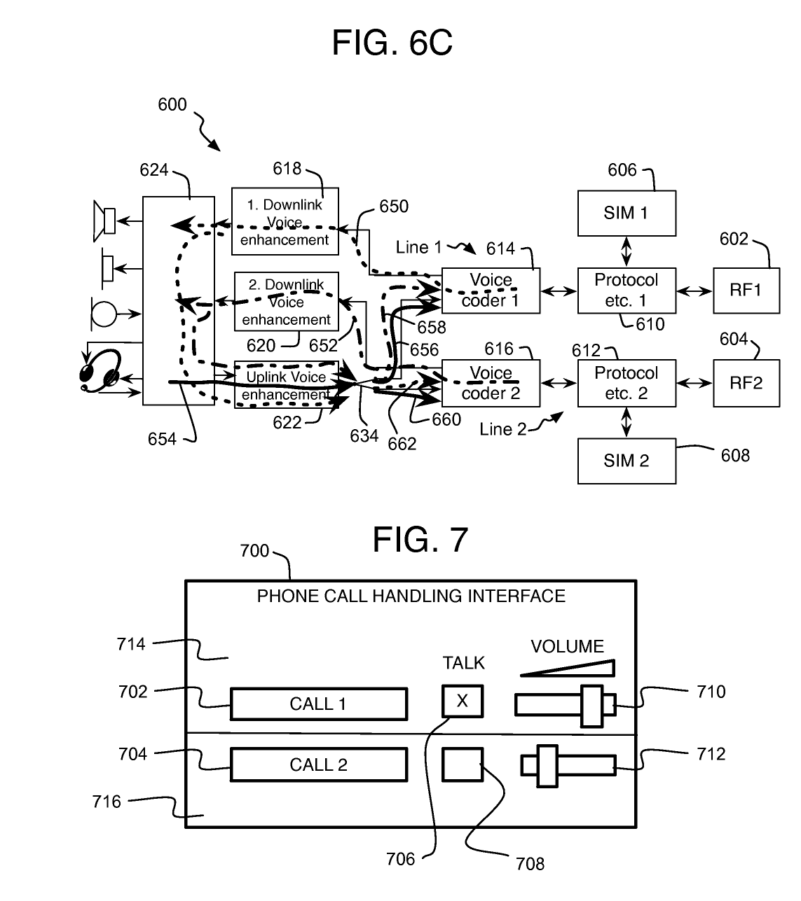

Referring to FIG. 6A, an example voice communication device or system 600 is used to illustrate the switching. The elements of the voice communication device 600 are similar to those provided for the voice communication device 100 (FIGS. 1-2), and correspond to the elements with similar names. Therefore, the description of the elements of device 600 are already described with the elements of device 100 and need not be repeated here. Device 600 shows two different phone lines 1 and 2 respectively with incoming or downlink signals 626 and 628 that are independently enhanced, and then provided to speakers 636 for example. An outgoing or uplink signal 630 is provided from a microphone, is enhanced, and then directed by switch 634 to the voice coder 1 for responding to the downlink signal 626 of line 1. Now it is assumed the user desires to switch his outgoing signal to the other downlink signal 628 of line 2. The desire to perform this switch may be indicated on the user interface 700 or otherwise as explained above.

Referring to FIG. 6C, this selection also may include the user indicating multiple or all (or both if only two are present) phone lines to receive the outgoing signal. In this case, a locally-based conference call is initiated. Thus, process 400 optionally then may include “redirect incoming signal(s) as outgoing signal(s) to other calls” 416. Specifically, in this case, the incoming signals 650 and 652 from phone lines 1 and 2 are redirected through the routing unit 624 as outgoing or uplink signals back to the uplink voice enhancement unit 622 for enhancement and emission to the phone lines to form the conference call.

Process 400 then may include “enhance outgoing signals” 418. By one form, the uplink voice enhancement is very complex since it may handle unwanted sounds picked up by the microphone in addition to the desired voice from the user. It is desirable to minimize transmission of any kind of background noise together with the voice, and especially in a loud speaker phone mode where the loud signal from the loud speaker will also be picked up by the microphone, and if not canceled, will form an echo back to the person on the other end of the line.

Process 400 may include “switch outgoing signal(s) to other call(s)” 420. This operation includes actually performing the switch. Thus, for the example voice communication device 600 provided above (FIGS. 6A-6B), the switch 634 is activated to change the path for the outgoing signal from the line 1 of downlink 626 to line 2 of downlink 628 as shown in FIG. 6B.

Referring to FIG. 6C, otherwise when the locally-based conference mode is activated, the switch is open to all inputs to the multiple lines that are to receive the outgoing signal, and in the usual case, to both lines when only two lines are present, but otherwise to all lines that are provided. Thus, as shown, the outgoing signal 654 is directed to both lines 1 and 2 as outgoing signals 656 and 660 from the switch 634. Additionally, the incoming or downlink signals 650 and 652 also are redirected through the routing unit 624 for uplink enhancement and then through switch 634 and as outgoing signals 662 and 658 respectively. There each signal 658 and 662 is directed to the other line or lines other than the line the signal originated from. Thus, the signal from line 1 is directed to line 2, and vice-versa. This effectively creates a conference call where all of the parties on the different lines can hear each other. It will be appreciated that the multiple phone call handling can be extended to combine more than two voice calls.

Once the switch is operated, the process loops to receive and enhance the next incoming signals at operation 405.

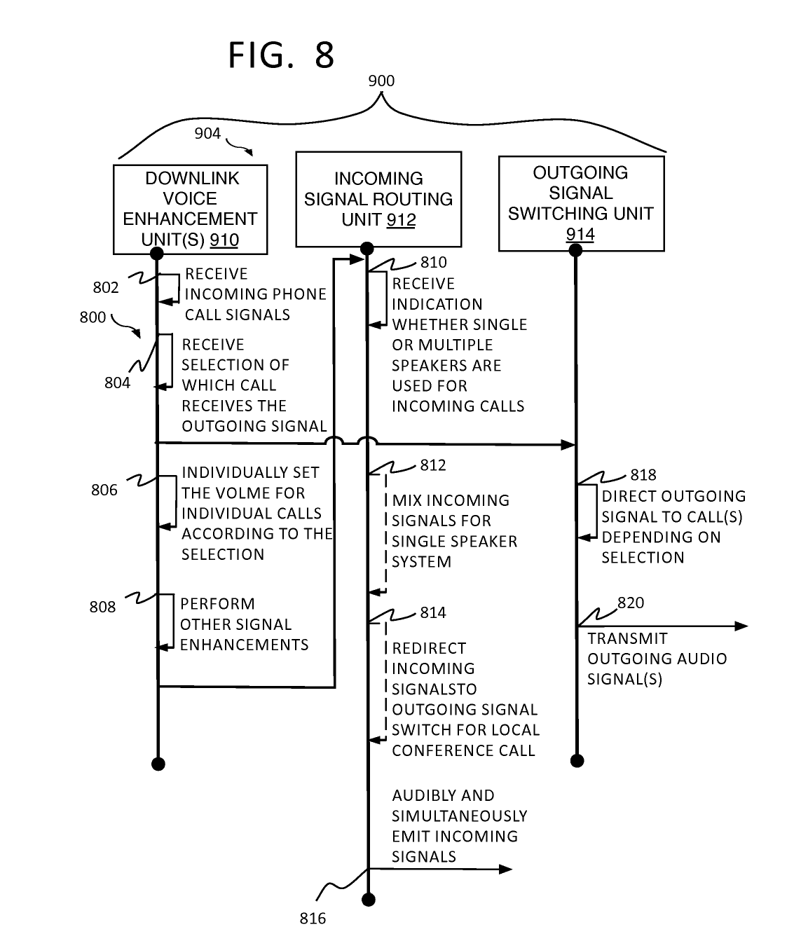

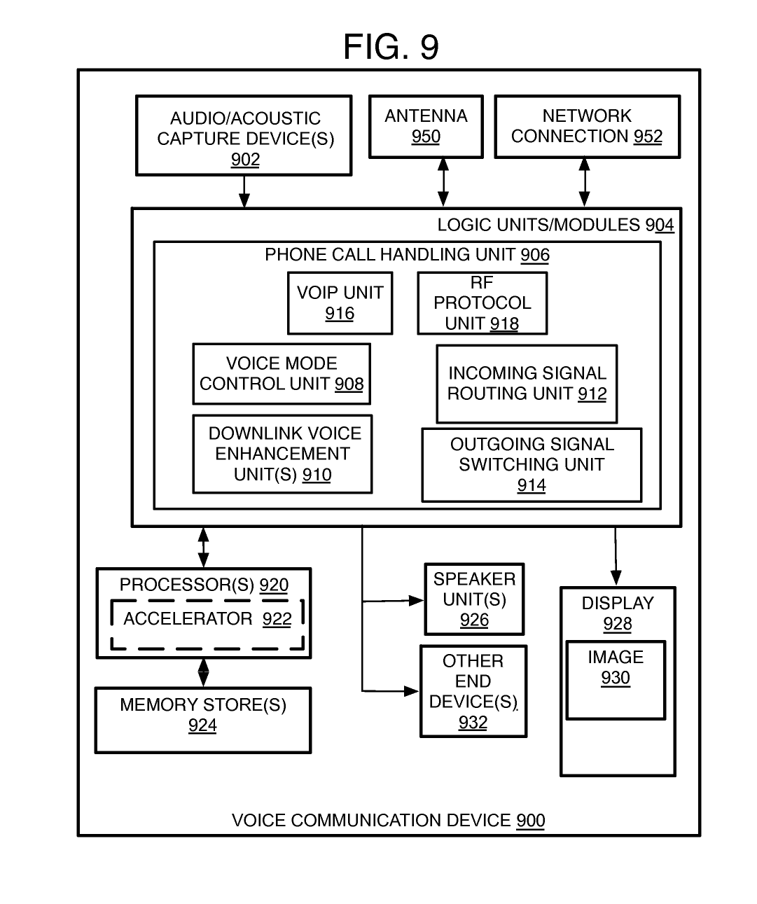

Referring to FIG. 8, by another approach, process 800 illustrates the operation of a voice communication system 900 that performs multiple voice call handling in accordance with at least some implementations of the present disclosure. In more detail, in the illustrated form, process 800 may include one or more operations, functions or actions as illustrated by one or more of actions 802 to 820 numbered evenly. By way of non-limiting example, process 800 will be described herein with reference to FIG. 9. Specifically, system or device 900 includes logic units 904 that includes a phone call handling unit 906 with downlink voice enhancement unit(s) 910, incoming signal routing unit 912, and an outgoing signal switching unit 914. The operation of the system may proceed as follows.

The process 800 provides the performance of a multiple voice or phone call handling algorithm as described above, where multiple phone calls can be listened to simultaneously, and where it is determined which one or more or the phone calls is to receive an outgoing audio or voice signal from the phone. The selection for directing the outgoing signal may be made by the user of the phone or performed automatically by the phone.

Thus, process 800 may include “receive incoming phone call signals” 802, and particularly, the voice or audio signals to establish multiple phone lines or calls.

The process 800 then may include “receive selection of which call receives the outgoing signal” 804, and as explained above, where the user or system may select which phone line is to receive the outgoing or uplink signal. The user may make the selection on a user interface or other devices as mentioned above.

The process 800 then may include “individually set the volume for individual calls according to the selection” 806. Thus, in one form, the call that should have the user's more immediate attention is to receive a higher volume than a call the user is simply monitoring and therefore should be audible in the background relative to the more immediate call. By one form, the call receiving the outgoing signal is considered the active call and the more immediate call and is set with the higher volume.

The process 800 may then include “perform other signal enhancements” 808. Thus, optionally, other downlink enhancements such as equalization, noise reduction, automatic level control, and so forth may be performed as described above to provide a clean signal for mixing if needed.

The process 800 may include “receive indication whether single or multiple speakers are used for incoming calls” 810. Thus, this will indicate whether the signals from the multiple phone lines should be mixed or not. In some alternatives, only the single speaker system receives a mixed signal such as for a loud speaker or headset, where systems with two speakers receive independent incoming or downlink signals to emit one on each speaker. By other forms, stereo systems such as on headphones or stereo loud speakers also may receive the mixed signal when desired.

The process 800 may include “mix incoming signals for single speaker system” 812. Thus, as mentioned, the signals are mixed together to form a single audio signal as explained above.

When desired, the process 800 also optionally may include “redirect incoming signals to outgoing signal switch for conference call” 814, such that a locally-based conference call may be established. This is accomplished, as mentioned above, by redirecting the incoming signals as outgoing signals back to the uplink enhancement unit and to a switch for directing the outgoing signals back to the phone line or lines that the signal did not originate from. This also directs the outgoing signal originating from the present voice communication device out to all of the phone lines providing an incoming signal (or all phone calls established).

The process 800 may include “audibly and simultaneously emit incoming signals” 816. Thus, as explained herein, the user may simultaneously hear all of the phone calls established on phone lines of the voice communication device, and in some forms, multiple or each of the phone calls will be set at a different volume.

The process 800 may include “direct outgoing signal to call(s) depending on selection” 818. Accordingly, a switch is controlled to direct the outgoing or uplink signals to one or more of the phone lines per the selection as explained above. Then, the process 800 may include “transmit outgoing audio signal(s)” 820, and thereby provide the outgoing signals to the phone lines.

It will be appreciated that processes 300, 400, and/or 800 may be provided by sample voice communication system 100 and/or 900 to operate at least some implementations of the present disclosure. This includes operation of a multiple phone call handling unit 906 and the units described therein and units similar in system 100 (FIGS. 1-2). It will be appreciated that the operations described for processes 300, 400, and/or 800 may be performed in a different order and may not all be performed for a particular process.

In addition, any one or more of the operations of FIGS. 3-4 and 8 may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more processor core(s) may undertake one or more of the operations of the example processes herein in response to program code and/or instructions or instruction sets conveyed to the processor by one or more computer or machine-readable media. In general, a machine-readable medium may convey software in the form of program code and/or instructions or instruction sets that may cause any of the devices and/or systems to perform as described herein. The machine or computer readable media may be a non-transitory article or medium, such as a non-transitory computer readable medium, and may be used with any of the examples mentioned above or other examples except that it does not include a transitory signal per se. It does include those elements other than a signal per se that may hold data temporarily in a “transitory” fashion such as RAM and so forth.

As used in any implementation described herein, the term “module” refers to any combination of software logic, firmware logic and/or hardware logic configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth. For example, a module may be embodied in logic circuitry for the implementation via software, firmware, or hardware of the coding systems discussed herein.

As used in any implementation described herein, the term “logic unit” refers to any combination of firmware logic and/or hardware logic configured to provide the functionality described herein. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality.

Referring to FIG. 9, an example voice communication device or system 900 to perform multiple phone call handling is arranged in accordance with at least some implementations of the present disclosure. In various implementations, the example voice communication device 900 may have a voice or audio/acoustic capture device(s) 902 such as one or more microphones to form or receive acoustical signal data, and one or more antennas 950 to wirelessly receive computer network signals and/or telecommunication signals. A computer and/or telecommunications network connection 952 may be provided to receive signals over wires. The antenna(s) 950 and connection 952 obtains the signals to establish one or more phone lines or phone calls. This can be implemented in various ways. Thus, in one form, the voice communication device 900 is a single physical device, such as a mobile phone, that transmits and receives voice signals in the form of streamed data from a computer network, PTSN voice signals, or both, establishes at least two separate phone call lines whether wirelessly or over network wiring, and emits the incoming signals over one or more speakers or other similar devices. By some examples, the voice communication device is a speaker or speaker system. By other alternatives, the voice communication device 900 may include audio capture devices, antenna, and speakers that are remote from logic units 904 performing the operations for the multiple phone call handling such as at a computer, router, or server that performs the switching among the phone lines for a phone. By other examples, the voice communication device 900 is itself a network with separate audio capture device and separate speaker both remote from the body operating the logic units. Many other examples exist. In these examples then, such technology may include a telephone, a smart phone, a tablet, a laptop, other mobile device or an on-board device, a desktop computer, or any combination of these.

The antenna(s) 950 may be configured to receive wireless computer or telephonic network signals and is not otherwise limited in form. The antenna may include any transmitters, receivers, and so forth to perform the operations herein. Likewise, the network connection 952 may include any connection suitable for computer communication, such as an Ethernet or USB port to name a few examples, and/or PTSN connections. The antenna(s) 950 and/or connection 952 may be implementing communication protocols/standards such as World Interoperability for Microwave Access (WiMAX), infrared protocols such as Infrared Data Association (IrDA), short-range wireless protocols/technologies, Bluetooth® technology, ZigBee® protocol, ultra wide band (UWB) protocol, home radio frequency (HomeRF), shared wireless access protocol (SWAP), wideband technology such as a wireless Ethernet compatibility alliance (WECA), wireless fidelity alliance (Wi-Fi Alliance), 802.11 network technology, public switched telephone network technology, public heterogeneous communications network technology such as the Internet, private wireless communications network, land mobile radio network, code division multiple access (CDMA), wideband code division multiple access (WCDMA), universal mobile telecommunications system (UMTS), advanced mobile phone service (AMPS), time division multiple access (TDMA), frequency division multiple access (FDMA), orthogonal frequency division multiple access (OFDMA), global system for mobile communications (GSM), single carrier (1×) radio transmission technology (RTT), evolution data only (EV-DO) technology, general packet radio service (GPRS), enhanced data GSM environment (EDGE), high speed downlink data packet access (HSPDA), analog and digital satellite systems, and any other technologies or protocols that may be used in at least one of a wireless communications network and a data communications network.

In one form, audio capture device 902 may include audio capture hardware including one or more sensors as well as actuator controls. These controls may be part of a sensor module or component for operating the sensor. The sensor component may be part of the audio capture device 902, or may be part of the logical modules 904 or both. Such sensor component can be used to convert sound waves into an electrical acoustic signal. The audio capture device 902 also may have an A/D converter, other filters, and so forth to provide a digital signal for acoustic signal processing and multiple voice or phone call handling.

In the illustrated example, the logic modules 904 may include a phone call handling unit 906 with a VoIP unit 916 and RF protocol unit 918 to permit and convert the network signals into usable phone line signals and vice-versa, which also may include decoding or encoding of the signals. A voice mode control unit 908 may be provided to receive users' selections or otherwise determines the desired mode for multiple phone calls, and provides the desired settings to the other units. The phone call handling unit 906 also may have downlink enhancement voice unit(s) 910, incoming signal routing unit 912, and outgoing signal switching unit 914. These units may be used to perform the operations described above where relevant.

The voice communication device 900 may have one or more processors 920 which may include a dedicated accelerator 922 such as the Intel Atom, memory stores 924 which may or may not hold phone line data mentioned herein, at least one speaker unit 926 to emit the phone call signals, one or more displays 928 to provide visual response to the audio signals, which may include images 930 of text from voice calls converted from signals, or a user interface to receive user input for the multiple phone call handling for example, other end device(s) 932 to perform actions in response to the acoustic signal such as a braille machine or other modules that respond automatically to voice phone line signals (such as telephonic or online audio service like voice mail for example). In one example implementation, the voice communication device 900 may have the audio capture device 902, the antenna(s) 950, the network connection 952, and the speaker unit 926 all communicatively coupled to at least one processor 920 and at least one memory 924. As illustrated, any of these components may be capable of communication with one another and/or communication with portions of logic modules 904. Thus, processors 920 may be communicatively coupled to the audio capture device 902, the antenna(s) 950, the network connection 952, and/or the speaker unit 926 to operate those components.

Although voice communication device 900, as shown in FIG. 9, may include one particular set of blocks or actions associated with particular components or modules, these blocks or actions may be associated with different components or modules than the particular component or module illustrated here.

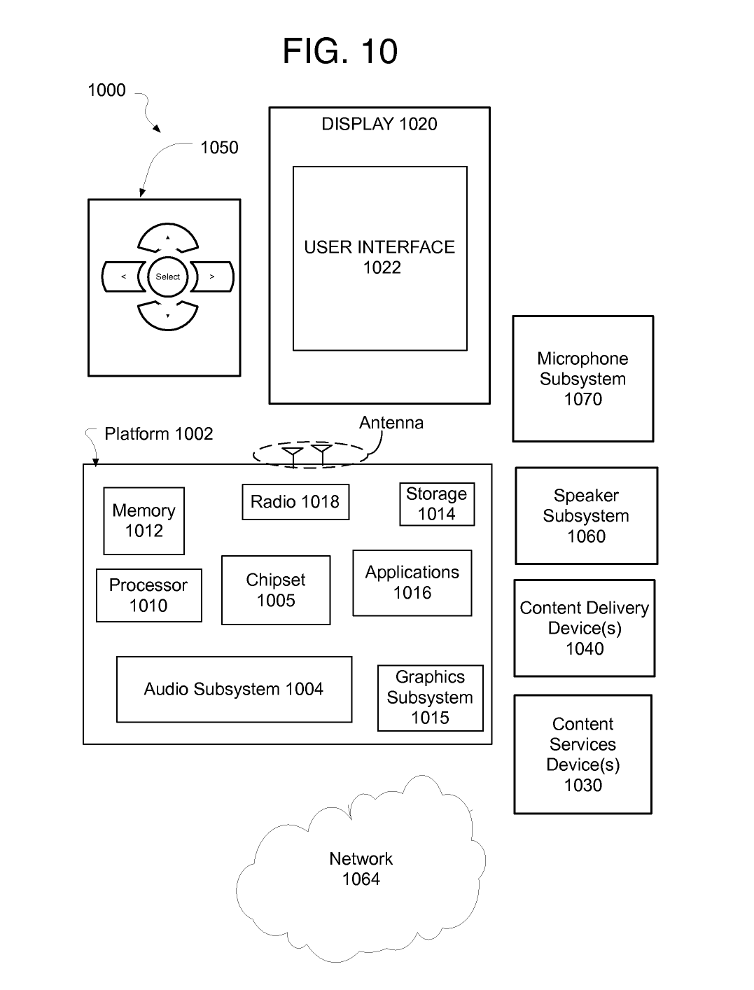

Referring to FIG. 10, an example voice communication device or system 1000 in accordance with the present disclosure operates one or more aspects of the multiple voice call handling methods described herein. It will be understood from the nature of the system components described below that such components may be associated with, or used to operate, certain part or parts of the voice communication devices or systems described above. In various implementations, system 1000 may be a media system although system 1000 is not limited to this context. For example, system 1000 may be incorporated into one or more cellular telephones, combination cellular telephone/PDA, television, smart device (e.g., smart phone, smart tablet or smart television), mobile internet device (MID), microphone, speakers, personal computer (PC), laptop computer, ultra-laptop computer, tablet, touch pad, portable computer, handheld computer, palmtop computer, personal digital assistant (PDA), messaging device, data communication device, and so forth, but otherwise any device having a connection to a telecommunications and/or computer network that may emit a transmitted audible signal, or provide some converted form of, or response to, the audible signal.

In various implementations, system 1000 includes a platform 1002 coupled to a display 1020. Platform 1002 may receive content from a content device such as content services device(s) 1030 or content delivery device(s) 1040 or other similar content sources. A navigation controller 1050 including one or more navigation features may be used to interact with, for example, platform 1002, speaker subsystem 1060, microphone subsystem 1070, and/or display 1020. Each of these components is described in greater detail below.

In various implementations, platform 1002 may include any combination of a chipset 1005, processor 1010, memory 1012, storage 1014, audio subsystem 1004, graphics subsystem 1015, applications 1016 and/or radio 1018. Chipset 1005 may provide intercommunication among processor 1010, memory 1012, storage 1014, audio subsystem 1004, graphics subsystem 1015, applications 1016 and/or radio 1018. For example, chipset 1005 may include a storage adapter (not depicted) capable of providing intercommunication with storage 1014.

Processor 1010 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 1010 may be dual-core processor(s), dual-core mobile processor(s), and so forth.

Memory 1012 may be implemented as a volatile memory device such as, but not limited to, a Random Access Memory (RAM), Dynamic Random Access Memory (DRAM), or Static RAM (SRAM).

Storage 1014 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1014 may include technology to increase the storage performance enhanced protection for valuable digital media when multiple hard drives are included, for example.

Audio subsystem 1004 may perform processing of audio such as acoustic signals for multiple phone call handling as described herein. The audio subsystem 1004 may comprise one or more processing units, memories, and accelerators. Such an audio subsystem may be integrated into processor 1010 or chipset 1005. In some implementations, the audio subsystem 1004 may be a stand-alone card communicatively coupled to chipset 1005. An interface may be used to communicatively couple the audio subsystem 1004 to a speaker subsystem 1060, microphone subsystem 1070, and/or display 1020.

The audio processing techniques described herein may be implemented in various hardware architectures. For example, audio functionality may be integrated within a chipset. Alternatively, a discrete audio processor may be used. As still another implementation, the audio functions may be provided by a general purpose processor, including a multi-core processor. In further embodiments, the functions may be implemented in a consumer electronics device. By one example, audio subsystem 1004 provides dual/multi SIM phone products (using either SLIM modems and/or SoCs by one example) but is not limited to this arrangement. Audio subsystem 1004 also may be provided as a single SIM product also with a computer connection (such as a Wi-Fi connection) for receiving audio signals from on-line applications using VoIP and online telephonic services, and so forth.

Graphics subsystem 1015 may perform processing of images such as still or video for display. Graphics subsystem 1015 may be a graphics processing unit (GPU) or a visual processing unit (VPU), for example. An analog or digital interface may be used to communicatively couple graphics subsystem 1015 and display 1020. For example, the interface may be any of a High-Definition Multimedia Interface, Display Port, wireless HDMI, and/or wireless HD compliant techniques. Graphics subsystem 1015 may be integrated into processor 1010 or chipset 1005. In some implementations, graphics subsystem 1015 may be a stand-alone card communicatively coupled to chipset 1005.

Radio 1018 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1018 may operate in accordance with one or more applicable standards in any version.

In various implementations, display 1020 may include any television, monitor, or display. Display 1020 may include, for example, a computer display screen, touch screen display, video monitor, television-like device, and/or a television. Display 1020 may be digital and/or analog. In various implementations, display 1020 may be a holographic display. Also, display 1020 may be a transparent surface that may receive a visual projection. Such projections may convey various forms of information, images, and/or objects. For example, such projections may be a visual overlay for a mobile augmented reality (MAR) application. Under the control of one or more software applications 1016, platform 1002 may display user interface 1022 on display 1020, which may be the same or similar to user interface 700.

In various implementations, content services device(s) 1030 may be hosted by any national, international and/or independent service and thus accessible to platform 1002 via the Internet, for example. Content services device(s) 1030 may be coupled to platform 1002 including audio subsystem 1004, and/or to display 1020, speaker subsystem 1060, and microphone subsystem 1070. Platform 1002 and/or content services device(s) 1030 may be coupled to a network 1064 to communicate (e.g., send and/or receive) media information to and from network 1064. Content delivery device(s) 1040 also may be coupled to platform 1002, speaker subsystem 1060, microphone subsystem 1070, and/or to display 1020.

In various implementations, content services device(s) 1030 may include a network of microphones, a cable television box, personal computer, network, telephone, Internet enabled devices or appliance capable of delivering digital information and/or content, and any other similar device capable of unidirectionally or bidirectionally communicating content between content providers and platform 1002 and speaker subsystem 1060, microphone subsystem 1070, and/or display 1020, via network 1065 or directly. It will be appreciated that the content may be communicated unidirectionally and/or bidirectionally to and from any one of the components in system 1000 and a content provider via network 1060. Examples of content may include any media information including, for example, video, music, medical and gaming information, and so forth.

Content services device(s) 1030 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1002 may receive control signals from navigation controller 1050 having one or more navigation features. The navigation features of controller 1050 may be used to interact with user interface 1022, for example. In embodiments, navigation controller 1050 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures. The audio subsystem 1004 also may be used to control the motion of articles or selection of commands on the interface 1022.

Movements of the navigation features of controller 1050 may be replicated on a display (e.g., display 1020) by movements of a pointer, cursor, focus ring, or other visual indicators displayed on the display or by audio commands. For example, under the control of software applications 1016, the navigation features located on navigation controller 1050 may be mapped to virtual navigation features displayed on user interface 1022, for example. In embodiments, controller 1050 may not be a separate component but may be integrated into platform 1002, speaker subsystem 1060, microphone subsystem 1070, and/or display 1020. The present disclosure, however, is not limited to the elements or in the context shown or described herein.

In various implementations, drivers (not shown) may include technology to enable users to instantly turn on and off platform 1002 like a television with the touch of a button after initial boot-up, when enabled, for example, or by auditory command. Program logic may allow platform 1002 to stream content to media adaptors or other content services device(s) 1030 or content delivery device(s) 1040 even when the platform is turned “off.” In addition, chipset 1005 may include hardware and/or software support for 8.1 surround sound audio and/or high definition (7.1) surround sound audio, for example. Drivers may include an auditory or graphics driver for integrated auditory or graphics platforms. In embodiments, the auditory or graphics driver may comprise a peripheral component interconnect (PCI) Express graphics card.

In various implementations, any one or more of the components shown in system 1000 may be integrated. For example, platform 1002 and content services device(s) 1030 may be integrated, or platform 1002 and content delivery device(s) 1040 may be integrated, or platform 1002, content services device(s) 1030, and content delivery device(s) 1040 may be integrated, for example. In various embodiments, platform 1002, speaker subsystem 1060, microphone subsystem 1070, and/or display 1020 may be an integrated unit. Display 1020, speaker subsystem 1060, and/or microphone subsystem 1070 and content service device(s) 1030 may be integrated, or display 1020, speaker subsystem 1060, and/or microphone subsystem 1070 and content delivery device(s) 1040 may be integrated, for example. These examples are not meant to limit the present disclosure.

In various implementations, system 1000 may be implemented as a wireless system, a wired system, or a combination of both. When implemented as a wireless system, system 1000 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1000 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1002 may establish one or more logical or physical channels to communicate information. The information may include media information and control information. Media information may refer to any data representing content meant for a user. Examples of content may include, for example, data from a voice conversation, videoconference, streaming video and audio, electronic mail (“email”) message, voice mail message, alphanumeric symbols, graphics, image, video, audio, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 10.

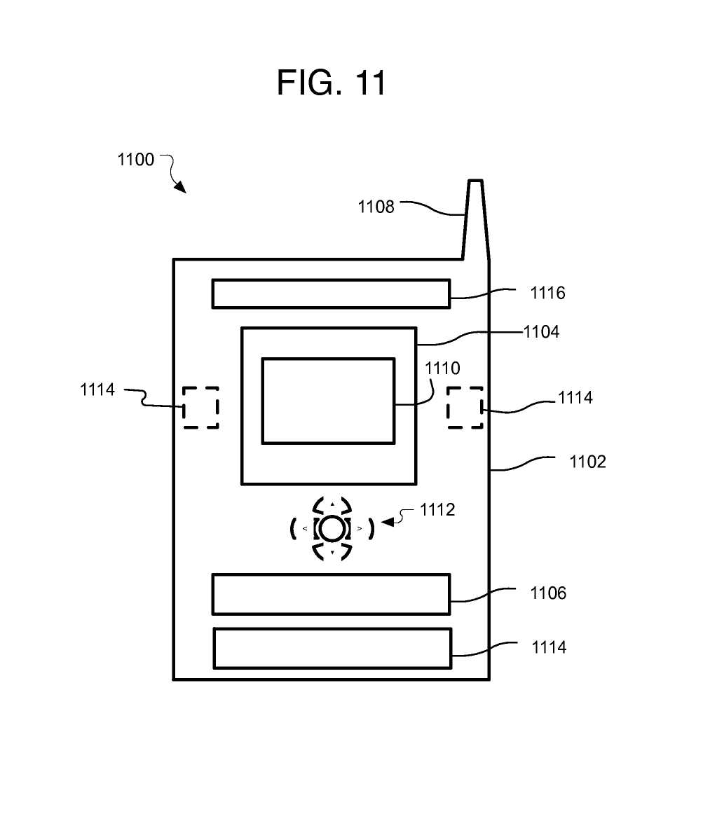

Referring to FIG. 11, a small form factor device 1100 is one example of the varying physical styles or form factors in which system 900 or 1000 may be embodied. By this approach, device 1100 may be implemented as a mobile computing device having wireless capabilities. A mobile computing device may refer to any device having a processing system and a mobile power source or supply, such as one or more batteries, for example.

As described above, examples of a mobile computing device may include any device with an audio sub-system such as a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, speaker system, microphone system or network, and so forth, and any other computer that may accept audio commands.

Examples of a mobile computing device also may include computers that are arranged to be worn by a person, such as a head-phone, head band, hearing aide, wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing and telephonic devices as well. The embodiments are not limited in this context.

As shown in FIG. 11, device 1100 may include a housing 1102, a display 1104 including a screen 1110, an input/output (I/O) device 1106, and at least one antenna 1108 that may receive telecommunications signals and/or wireless computer network signals. Device 1100 also may include navigation features 1112. Display 1104 may include any suitable display unit for displaying information appropriate for a mobile computing device. I/O device 1106 may include any suitable I/O device for entering information into a mobile computing device. Examples for I/O device 1106 may include an alphanumeric keyboard, a numeric keypad, a touch pad, input keys, buttons, switches, rocker switches, software and so forth. Information also may be entered into device 1100 by way of network of two or more microphones 1114. Such information may be processed by a multiple phone call handling device as described herein as well as telecommunications modules as part of the device 1100, and may provide audio responses via a speaker 1116 and/or visual responses via screen 1110. The implementations are not limited in this context.

Various forms of the devices and processes described herein may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further implementations.

By one example, a computer-implemented method of multiple voice call handling comprises receiving, at a first voice communication device, multiple incoming audio signals from at least two remote voice communication devices establishing at least two phone calls; and simultaneously and audibly emitting, by the first voice communication device, the multiple incoming audio signals while individually controlling which one or more of the phone calls is to receive a transmission of an audible outgoing signal from the first communication device.

By another implementation, the method also may comprise providing all of the options of: (1) individually adjusting the volume of the simultaneously audible incoming audio signals, (2) providing the volume of an incoming audio signal of a current active phone call higher than the volume of the incoming audio signal of a background phone call to be monitored, and (3) providing the volume of an incoming audio signal of a phone call receiving the outgoing signal higher than the volume of a phone call not receiving the outgoing signal. The method may also comprise providing all of the options of: (a) treating at least two of the incoming audio signals as separate phone lines so that the remote voice communication devices are not in active communication with each other and cannot receive each other's incoming audio signals while the first communication device permits the simultaneous audible emission of the incoming audible signals at the first communication device; (b) receiving one of the at least two incoming audio signals as a single conference call with multiple remote voice communication devices on the single call, and the other of the at least two incoming audio signals is from a single remote voice communication device; and (c) forming a locally-based conference call by redirecting incoming audio signals to form corresponding outgoing audio signals receivable by the remote voice communication devices. Additionally, the method may comprise providing all of the options of: (A) mixing the incoming audible signals so that at least two of the incoming audio signals can be audible on a single speaker device, and mixing the incoming audio signals to be audible on a single speaker after individual enhancement of the audio signals including setting the volume of individual audio signals at different levels; and (B) simultaneously emitting one incoming audio signal on one speaker device of the first communication device and emitting another of the incoming audio signals on another speaker device of the first communication device.

By yet another implementation, a computer-implemented system of multiple voice call handling comprises a first voice communication device to receive multiple incoming audio signals from at least two remote voice communication devices to establish at least two phone calls, at least one processor of the first voice communication device, at least one memory communicatively coupled to the at least one processor, and a phone call handling unit communicatively coupled to the at least one processor and memory, and the phone call handling unit to simultaneously and audibly emit the multiple incoming audio signals while individually controlling which one or more of the phone calls is to receive a transmission of an audible outgoing signal from the first communication device.

By another example, the system provides that the phone call handling unit is to individually adjust the volume of the simultaneously audible incoming audio signals, and provides all of the options: (1) wherein the phone call handling unit is to provide the volume of an incoming audio signal of a current active phone call higher than the volume of the incoming audio signal of a background phone call to be monitored; (2) wherein the phone call handling unit is to treat at least two of the incoming audio signals as separate phone lines so that the remote voice communication devices are not in active communication with each other and cannot receive each other's incoming audio signals while the first communication device permits the simultaneous audible emission of the incoming audible signals at the first communication device; and (3) wherein the phone call handling unit is to form a locally-based conference call by redirecting incoming audio signals to form corresponding outgoing audio signals receivable by the remote voice communication devices.

Also, by one form, the handling unit is to provide all of the options: (A) wherein the phone call handling unit is to mix the incoming audible signals so that at least two of the incoming audio signals can be heard from a single speaker device; and (B) wherein the phone call handling unit is to simultaneously emit one incoming audio signal on one speaker of the first communication device and emit another of the incoming audio signals on another speaker of the first communication device.

Such a system may also comprise an activator arranged to permit a user of the first voice communication device to switch among the incoming audio signals to provide an outgoing audio signal to the originator of a selected one or more of the incoming audio signals, and arranged to permit a user of the first voice communication device to individually control the volume of the incoming audio signals; and a display that lists the phone calls, which phone call is receiving the outgoing audio signal, and the volume for each phone call, wherein the incoming audio signals are simultaneously emitted on at least one of: a single loud speaker, a single ear piece of a headset, respectively on multiple stereo loud speakers, and respectively on multiple speakers of a headphone.

By one approach, at least one computer readable medium comprises a plurality of instructions that in response to being executed on a computing device, causes the computing device to: receive, at a first voice communication device, multiple incoming audio signals from at least two remote voice communication devices establishing at least two phone calls; and simultaneously and audibly emit, by the first voice communication device, the multiple incoming audio signals while individually controlling which one or more of the phone calls is to receive a transmission of an audible outgoing signal from the first communication device.

By another approach, the instructions cause the computing device to provide all of the options of: (1) individually adjust the volume of the simultaneously audible incoming audio signals, (2) provide the volume of an incoming audio signal of a current active phone call higher than the volume of the incoming audio signal of a background phone call to be monitored, and (3) provide the volume of an incoming audio signal of a phone call receiving the outgoing signal higher than the volume of a phone call not receiving the outgoing signal.

Also, the instructions cause the computing device to provide all of the options of: (a) treat at least two of the incoming audio signals as separate phone lines so that the remote voice communication devices are not in active communication with each other and cannot receive each other's incoming audio signals while the first communication device permits the simultaneous audible emission of the incoming audible signals at the first communication device; (b) receive one of the at least two incoming audio signals as a single conference call with multiple remote voice communication devices on the single call, and the other of the at least two incoming audio signals is from a single remote voice communication device; and (c) form a locally-based conference call by redirecting incoming audio signals to form corresponding outgoing audio signals receivable by the remote voice communication devices. The instructions cause the computing device to provide all of the options of: (A) mix the incoming audible signals so that at least two of the incoming audio signals can be audible on a single speaker device, and mixing the incoming audio signals to be audible on a single speaker after individual enhancement of the audio signals including setting the volume of individual audio signals at different levels; and (B) simultaneously emit one incoming audio signal on one speaker device of the first communication device and emitting another of the incoming audio signals on another speaker device of the first communication device.

In a further example, at least one machine readable medium may include a plurality of instructions that in response to being executed on a computing device, causes the computing device to perform the method according to any one of the above examples.

In a still further example, an apparatus may include means for performing the methods according to any one of the above examples.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to any example methods herein may be implemented with respect to any example apparatus, example systems, and/or example articles, and vice versa.

What is claimed is:

1. A computer-implemented method of multiple voice call handling comprising:
receiving, at a first voice communication device, multiple incoming audio signals from at least two remote voice communication devices establishing at least two phone calls; and
simultaneously and audibly emitting, by the first voice communication device, the multiple incoming audio signals while individually controlling which one or more of the phone calls is to receive a transmission of an audible outgoing signal from the first communication device.

2. The method of claim 1 comprising individually adjusting the volume of the simultaneously audible incoming audio signals.

3. The method of claim 2 comprising providing the volume of an incoming audio signal of a current active phone call higher than the volume of the incoming audio signal of a background phone call to be monitored.

4. The method of claim 2 comprising providing the volume of an incoming audio signal of a phone call receiving the outgoing signal higher than the volume of a phone call not receiving the outgoing signal.

5. The method of claim 1 comprising treating at least two of the incoming audio signals as separate phone lines so that the remote voice communication devices are not in active communication with each other and cannot receive each other's incoming audio signals while the first communication device permits the simultaneous audible emission of the incoming audible signals at the first communication device.

6. The method of claim 5 comprising receiving one of the at least two incoming audio signals as a single conference call with multiple remote voice communication devices on the single call, and the other of the at least two incoming audio signals is from a single remote voice communication device.

7. The method of claim 1 comprising forming a locally-based conference call by redirecting incoming audio signals to form corresponding outgoing audio signals receivable by the remote voice communication devices.

8. The method of claim 1 comprising mixing the incoming audible signals so that at least two of the incoming audio signals can be audible on a single speaker device.

9. The method of claim 1 comprising mixing the incoming audio signals to be audible on a single speaker after individual enhancement of the audio signals including setting the volume of individual audio signals at different levels.

10. The method of claim 1 comprising simultaneously emitting one incoming audio signal on one speaker device of the first communication device and emitting another of the incoming audio signals on another speaker device of the first communication device.

11. The method of claim 1 comprising providing all of the options of:
(1) individually adjusting the volume of the simultaneously audible incoming audio signals,
(2) providing the volume of an incoming audio signal of a current active phone call higher than the volume of the incoming audio signal of a background phone call to be monitored, and
(3) providing the volume of an incoming audio signal of a phone call receiving the outgoing signal higher than the volume of a phone call not receiving the outgoing signal;
the method comprising providing all of the options of:
(a) treating at least two of the incoming audio signals as separate phone lines so that the remote voice communication devices are not in active communication with each other and cannot receive each other's incoming audio signals while the first communication device permits the simultaneous audible emission of the incoming audible signals at the first communication device;
(b) receiving one of the at least two incoming audio signals as a single conference call with multiple remote voice communication devices on the single call, and the other of the at least two incoming audio signals is from a single remote voice communication device; and
(c) forming a locally-based conference call by redirecting incoming audio signals to form corresponding outgoing audio signals receivable by the remote voice communication devices; and
the method comprising providing all of the options of:
(A) mixing the incoming audible signals so that at least two of the incoming audio signals can be audible on a single speaker device, and mixing the incoming audio signals to be audible on a single speaker after individual enhancement of the audio signals including setting the volume of individual audio signals at different levels; and
(B) simultaneously emitting one incoming audio signal on one speaker device of the first communication device and emitting another of the incoming audio signals on another speaker device of the first communication device.

12. A computer-implemented system of multiple voice call handling, comprising:
a first voice communication device to receive multiple incoming audio signals from at least two remote voice communication devices to establish at least two phone calls;
at least one processor of the first voice communication device;
at least one memory communicatively coupled to the at least one processor; and
a phone call handling unit communicatively coupled to the at least one processor and memory, and the phone call handling unit to simultaneously and audibly emit the multiple incoming audio signals while individually controlling which one or more of the phone calls is to receive a transmission of an audible outgoing signal from the first communication device.

13. The system of claim 12 wherein the phone call handling unit is to individually adjust the volume of the simultaneously audible incoming audio signals.

14. The system of claim 13 wherein the phone call handling unit is to provide the volume of an incoming audio signal of a current active phone call higher than the volume of the incoming audio signal of a background phone call to be monitored.

15. The system of claim 12 wherein the phone call handling unit is to treat at least two of the incoming audio signals as separate phone lines so that the remote voice communication devices are not in active communication with each other and cannot receive each other's incoming audio signals while the first communication device permits the simultaneous audible emission of the incoming audible signals at the first communication device.

16. The system of claim 12 wherein the phone call handling unit is to form a locally-based conference call by redirecting incoming audio signals to form corresponding outgoing audio signals receivable by the remote voice communication devices.

17. The system of claim 12 wherein the phone call handling unit is to mix the incoming audible signals so that at least two of the incoming audio signals can be heard from a single speaker device.

18. The system of claim 12 wherein the phone call handling unit is to simultaneously emit one incoming audio signal on one speaker of the first communication device and emit another of the incoming audio signals on another speaker of the first communication device.

19. The system of claim 12 comprising an activator arranged to permit a user of the first voice communication device to switch among the incoming audio signals to provide an outgoing audio signal to the originator of a selected one or more of the incoming audio signals.

20. The system of claim 12 comprising an activator arranged to permit a user of the first voice communication device to individually control the volume of the incoming audio signals.

21. The system of claim 12 comprising a display that lists the phone calls, which phone call is receiving the outgoing audio signal, and the volume for each phone call.

22. The system of claim 12 wherein the incoming audio signals are simultaneously emitted on at least one of:
a single loud speaker,
a single ear piece of a headset,
respectively on multiple stereo loud speakers, and
respectively on multiple speakers of a headphone.

23. The system of claim 12 wherein the phone call handling unit is to individually adjust the volume of the simultaneously audible incoming audio signals, and provides all of the options:
(1) wherein the phone call handling unit is to provide the volume of an incoming audio signal of a current active phone call higher than the volume of the incoming audio signal of a background phone call to be monitored;
(2) wherein the phone call handling unit is to treat at least two of the incoming audio signals as separate phone lines so that the remote voice communication devices are not in active communication with each other and cannot receive each other's incoming audio signals while the first communication device permits the simultaneous audible emission of the incoming audible signals at the first communication device;
(3) wherein the phone call handling unit is to form a locally-based conference call by redirecting incoming audio signals to form corresponding outgoing audio signals receivable by the remote voice communication devices;
the handling unit to provide all of the options:
(A) wherein the phone call handling unit is to mix the incoming audible signals so that at least two of the incoming audio signals can be heard from a single speaker device;
(B) wherein the phone call handling unit is to simultaneously emit one incoming audio signal on one speaker of the first communication device and emit another of the incoming audio signals on another speaker of the first communication device.
the system comprising an activator arranged to permit a user of the first voice communication device to switch among the incoming audio signals to provide an outgoing audio signal to the originator of a selected one or more of the incoming audio signals, and arranged to permit a user of the first voice communication device to individually control the volume of the incoming audio signals; and
a display that lists the phone calls, which phone call is receiving the outgoing audio signal, and the volume for each phone call;
wherein the incoming audio signals are simultaneously emitted on at least one of:
a single loud speaker,
a single ear piece of a headset,
respectively on multiple stereo loud speakers, and
respectively on multiple speakers of a headphone.

24. At least one computer readable medium comprising a plurality of instructions that in response to being executed on a computing device, causes the computing device to:
receive, at a first voice communication device, multiple incoming audio signals from at least two remote voice communication devices establishing at least two phone calls; and
simultaneously and audibly emit, by the first voice communication device, the multiple incoming audio signals while individually controlling which one or more of the phone calls is to receive a transmission of an audible outgoing signal from the first communication device.

25. The medium of claim 24, wherein the instructions cause the computing device to provide all of the options of:
(1) individually adjust the volume of the simultaneously audible incoming audio signals,
(2) provide the volume of an incoming audio signal of a current active phone call higher than the volume of the incoming audio signal of a background phone call to be monitored, and
(3) provide the volume of an incoming audio signal of a phone call receiving the outgoing signal higher than the volume of a phone call not receiving the outgoing signal;
the instructions cause the computing device to provide all of the options of:
(a) treat at least two of the incoming audio signals as separate phone lines so that the remote voice communication devices are not in active communication with each other and cannot receive each other's incoming audio signals while the first communication device permits the simultaneous audible emission of the incoming audible signals at the first communication device;
(b) receive one of the at least two incoming audio signals as a single conference call with multiple remote voice communication devices on the single call, and the other of the at least two incoming audio signals is from a single remote voice communication device; and
(c) form a locally-based conference call by redirecting incoming audio signals to form corresponding outgoing audio signals receivable by the remote voice communication devices; and
the instructions cause the computing device to provide all of the options of:
(A) mix the incoming audible signals so that at least two of the incoming audio signals can be audible on a single speaker device, and mixing the incoming audio signals to be audible on a single speaker after individual enhancement of the audio signals including setting the volume of individual audio signals at different levels; and
(B) simultaneously emit one incoming audio signal on one speaker device of the first communication device and emitting another of the incoming audio signals on another speaker device of the first communication device.
